(19) United States
(12) Patent Application Publication
(10) Pub. No.: US 2020/0156711 A1
(43) Pub. Date: May 21, 2020

(54) PULTRUDED BEAM WITH TRACER ELEMENT FOR LOCATING FIBER REINFORCEMENT POSITION

(71) Applicant: Shape Corp., Grand Haven, MI (US)

(72) Inventors: Kenneth H. Workinger, Spring Lake, MI (US); Jeffrey A. McHenry, Norton Shores, MI (US); Toby K. Jacobson, West Olive, MI (US); Paul M. Roehm, Grand Haven, MI (US)

(21) Appl. No.: 16/688,901

(22) Filed: Nov. 19, 2019

Related U.S. Application Data
(60) Provisional application No. 62/769,178, filed on Nov. 19, 2018.

(51) Int. Cl. B62D 29/00; B29C 70/52; B29C 70/54

(52) U.S. Cl. CPC B62D 29/001; B29C 70/523; B62D 21/00; B29C 70/545; B29C 70/543

(57) ABSTRACT

A pultruded profile is provided that has fiber reinforcements longitudinally extending parallel relative to each other along the length of the pultruded profile. A tracer element is disposed longitudinally along one of fiber reinforcements. A resin is disposed over the fiber reinforcements and the tracer element to form a consistent cross-sectional shape continuously along a length of the pultruded profile. The tracer element is identifiable at a cut end of the pultruded profile to provide an indication of a location of the corresponding fiber reinforcement of the plurality of fiber reinforcements in the pultruded profile.

### CROSS REFERENCE TO RELATED APPLICATIONS

This non-provisional U.S. Patent Application claims priority under 35 U.S.C. § 119(e) to U.S. Provisional Patent Application Ser. No. 62/769,178, filed Nov. 19, 2018, the disclosure of which is hereby incorporated by reference in its entirety.

### TECHNICAL FIELD

The present disclosure generally relates to pultruded profiles, such as structural members and beams, along with systems and processes for forming such profiles.

### BACKGROUND

Vehicles, such as automobiles, typically have a rigid structural frame or body structure, which is commonly referred to as a body-in-white or a body-in-black. To reduce vehicle weight for improved vehicle performance, it is desirable for various vehicle parts and components to be produced with light weight composite materials, such as carbon fiber reinforced resin materials. With respect to impact reinforcement and structural beams used in a vehicle body or frame, it is generally known that these beams may be provided as fiber reinforced beams, such as a pultruded fiber reinforced beams, to provide weight reduction.

### SUMMARY

The present disclosure provides a pultruded profile, such as an elongated beam for a vehicle body frame, and a method of manufacturing the same. The pultruded profile may be formed with a pultrusion process that uses a resin system or resin matrix, such as a thermosetting resin (e.g. formulations of polyurethane, epoxy, or the like), and continuous reinforcements imbedded within the resin, such as fiber reinforcements that may extend along a length of the profile and may be arranged in the profile in strategic locations for the cross-sectional design of the profile. The pultrusion process may provide an injection die that is shaped or configured to form a desired cross-sectional shape of the profile and may also be configured to form a longitudinal shape or curvature along the length of the beam. The cross-sectional shape of the pultruded profile may include various shapes for the desired application of the profile, such as an open shape (e.g., I-beams, T-profiles, L-profiles, U-channels, or the like) or a closed shape (e.g., a single tube or multi-tubular profile that has one or more hollow interior area that extends longitudinally within the profile). When confirming whether a fiber reinforcement is present and properly located in the cross section of the profile, a tracer element may be disposed along the fiber reinforcement. The tracer element may function as an identifiable locator at a cut end of the profile and thereby provide an indication of the presence and/or location of the fiber reinforcement within the cross section of the profile.

According to one aspect of the present disclosure, a pultruded profile includes fiber reinforcements that longitudinally extend parallel relative to each other. A tracer element is disposed at and extending longitudinally along a fiber reinforcement of the plurality of fiber reinforcements. A resin is disposed over the fiber reinforcements and the tracer element to form a consistent cross-sectional shape continuously along a length of the pultruded profile. The tracer element is identifiable at a cut end of the pultruded profile to provide an indication of a location of the corresponding fiber reinforcement in the pultruded profile.

The tracer element may include a material that is different from the fiber reinforcements, such as a photoluminescent material, a glass material, or a metal wire, so that the tracer element is capable of being detected (e.g., by human inspection without the use of visual magnification aid) at the cut end to determine a location of the tracer element on the cut end of the pultruded profile. For example, the tracer element may include a high visibility material that is visually identifiable from the pigment of the resin, such as a fluorescent or photoluminescent material that can emit light or a reflective material that reflects light or a brightly colored material. In another example, the tracer element may include an optical fiber filament (e.g., a glass filament) that is configured to receive light at an opposite end of the profile from the cut end, so as to illuminate the glass filament at the cut end of the profile.

The profile may be designed for a fiber fabric (e.g., a woven or stitched fabric construction) to be disposed in a desired location in the cross-sectional shape of the profile. The tracer element may be disposed longitudinally along a consistent portion of the fiber fabric, such as at a central portion or an edge portion of the fiber fabric, whereby the identification of the tracer element at the cut end of the pultruded profile provides an indication of the whether the location of the fiber fabric in the formed profile corresponds with its desired or desinged location. Also, the fiber fabric may be provided with one or more tracer elements to increase visibility at desired locations of the fiber fabric. For example, an additional tracer element may be provided longitudinally along the opposing edge portions of the fiber fabric, such that locations of both edges of the fiber fabric may be monitored in the cut ends of the pultruded profile. When using more than one tracer element in a profile, the various tracer elements may include different materials or colors, so as to distinguish the corresponding portions or fabrics associated with the tracer elements.

Optionally, the elongated profile may have a closed cross-sectional shape that includes one or more hollow interior areas spanning longitudinally within the profile, where the fiber fabric may be disposed at a wall portion that borders at least one of the hollow interior areas. The opposing outer surfaces of the wall portion may define a thickness of the wall portion, where the fiber fabric may be imbedded in the thickness of the resin material between the outer surfaces. Further, the elongated profile may, optionally, include at least one flange that protrudes from the tubular portion, where the fiber fabric may extend from the wall portion of the tubular portion to the flange.

According to another aspect of the present disclosure, a pultruded profile includes fiber reinforcements that extend longitudinally parallel relative to each other, where the fiber reinforcements include a fiber fabric with a stitched, non-crimped construction. A tracer element may be attached at and extend longitudinally along a portion of the fiber fabric, where the tracer element may include a material that is different from the fiber reinforcements, such that the tracer element is identifiable at a cut end of the pultruded profile. A resin may be disposed over the fiber reinforcements and the tracer element to form a consistent cross-sectional shape continuously along a length of the pultruded profile. The resin may include a pigment that corresponds with a color of a carbon fiber material of the plurality of fiber reinforcements.

According to yet another aspect of the present disclosure, a method of forming a pultruded profile provides pulling fiber reinforcements into and through a pultrusion die in a desired arrangement within the cross-sectional shape of the pultrusion die. The desired arrangement includes positioning a fiber fabric of the fiber reinforcements in a desired location on the cross-sectional shape. A tracer element is disposed longitudinally along a portion of the fiber fabric A resin is injected over the fiber reinforcements in the pultrusion die to form an elongated profile with the cross-sectional shape. The elongated profile is cut to form a cut end of the pultruded profile, wherein the tracer element is configured to be identifiable at the cut end of the pultruded profile.

Optionally, the method may further include identifying the tracer element at the cut end of the pultruded profile to provide a locating marker to determine whether the fiber fabric is disposed in the desired location. For example, a sensor may be directed at the cut end of the pultruded profile to detect the tracer element for identifying at least one of: (a) the presence of the fiber fabric in the pultruded profile or (b) the location of the fiber fabric in the cross-sectional shape of the pultruded profile. Such a sensor may, for example, be configured to detect the tracer element based on its receipt or detection of (a) visible light waves, (b) heat, (c) electricity, or (d) magnetic waves.

These and other objects, advantages, purposes, and features of the present disclosure will become apparent upon review of the following specification in conjunction with the drawings.

### BRIEF DESCRIPTION OF THE DRAWINGS

FIG. 1 is an perspective view of a vehicle, showing various structural components of the vehicle in dashed lines;

FIG. 2 is a side elevational view of the vehicle shown in FIG. 1;

FIG. 3 is a partial perspective view of a vehicle showing an additional structural component;

FIG. 4 is a perspective view of a pultruded profile with tracer elements;

FIG. 4A is an enlarged perspective view of an end portion of the pultruded profile shown in FIG. 4, showing the tracer elements in dashed lines;

FIG. 5 is a cross-sectional view of the pultruded profile shown in FIG. 4, showing fiber reinforcements and corresponding tracer elements;

FIG. 6 is an end view of the pultruded profile shown in FIG. 4;

FIG. 7A is an enlarged view of a section of the end of the pultruded profile shown in

FIG. 6, showing fiber reinforcements in dashed lines;

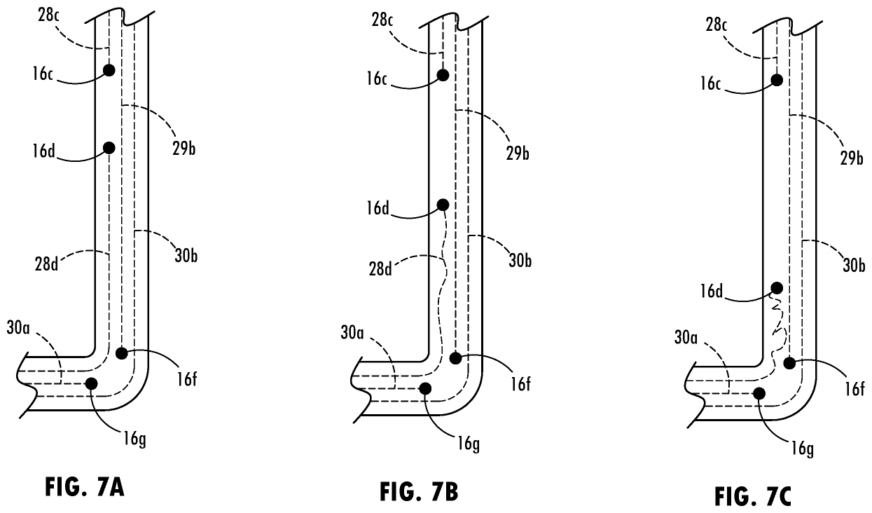

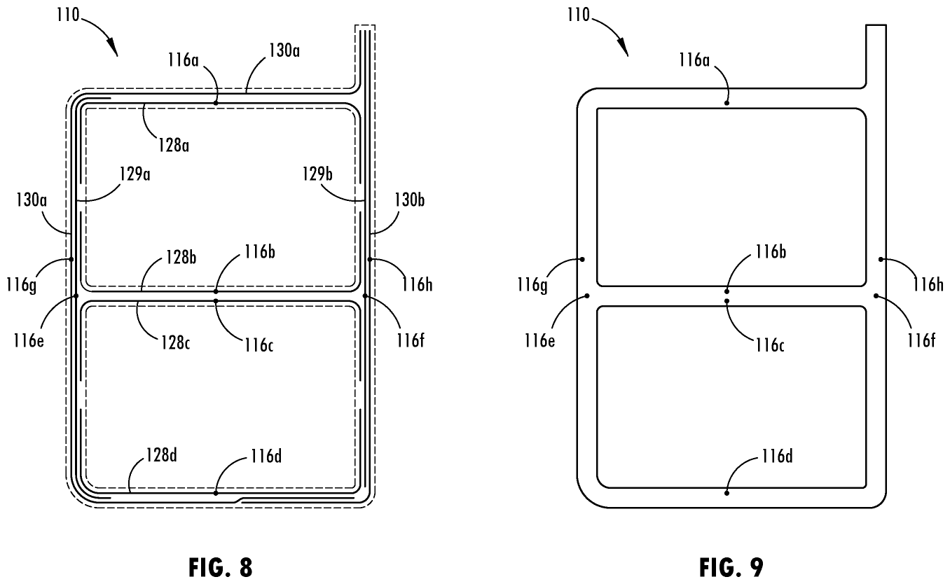

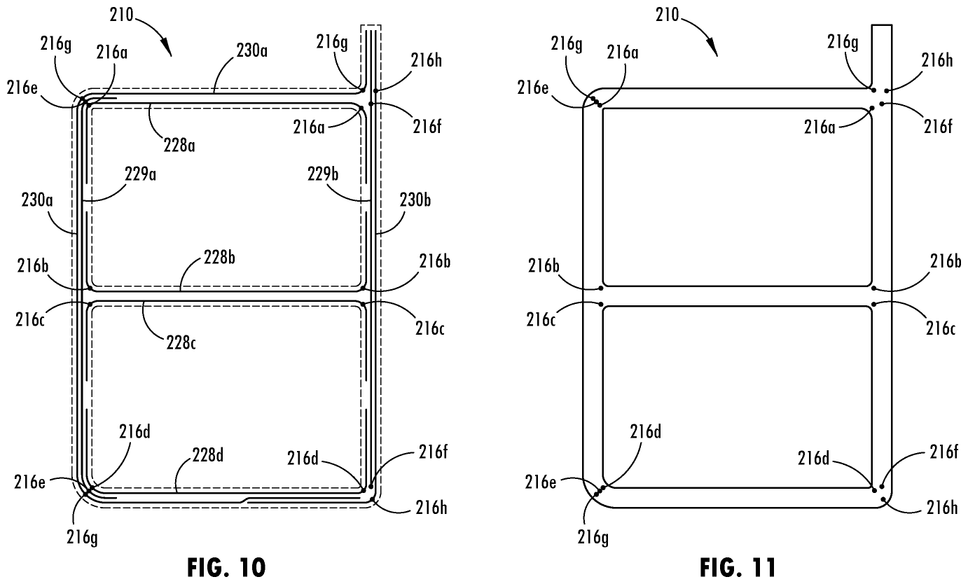

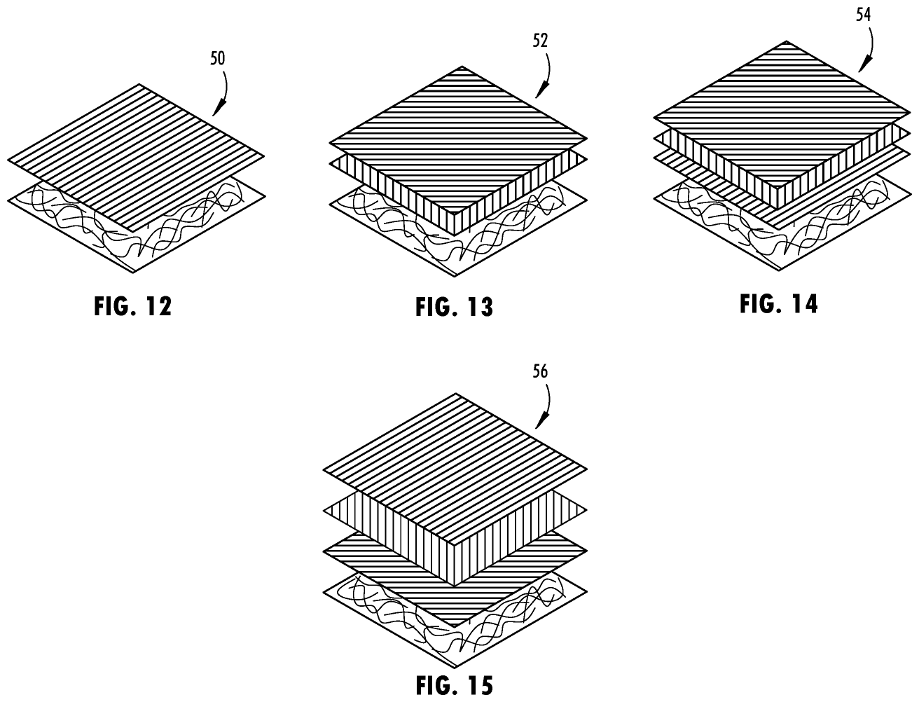

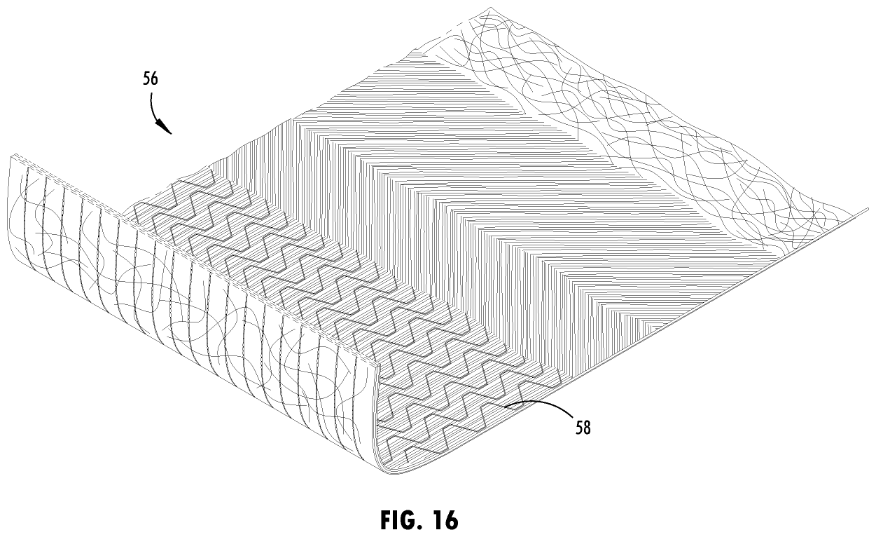

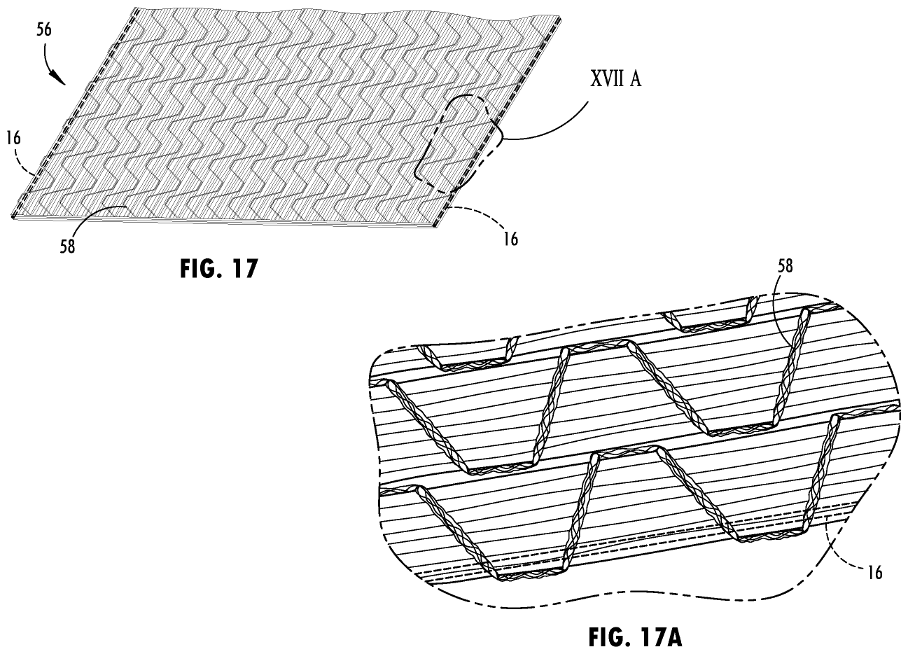

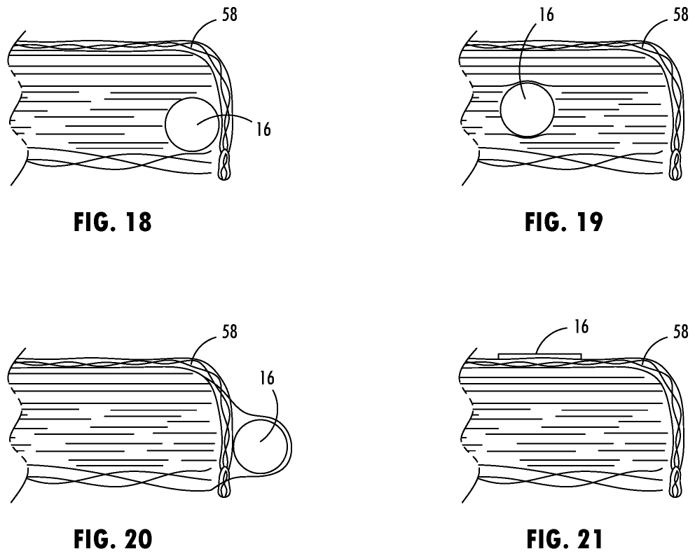

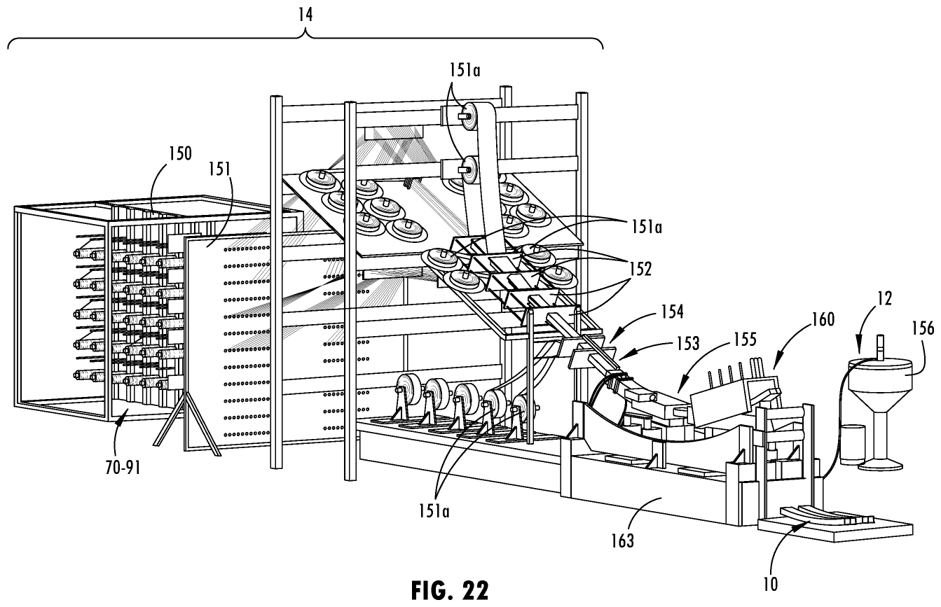

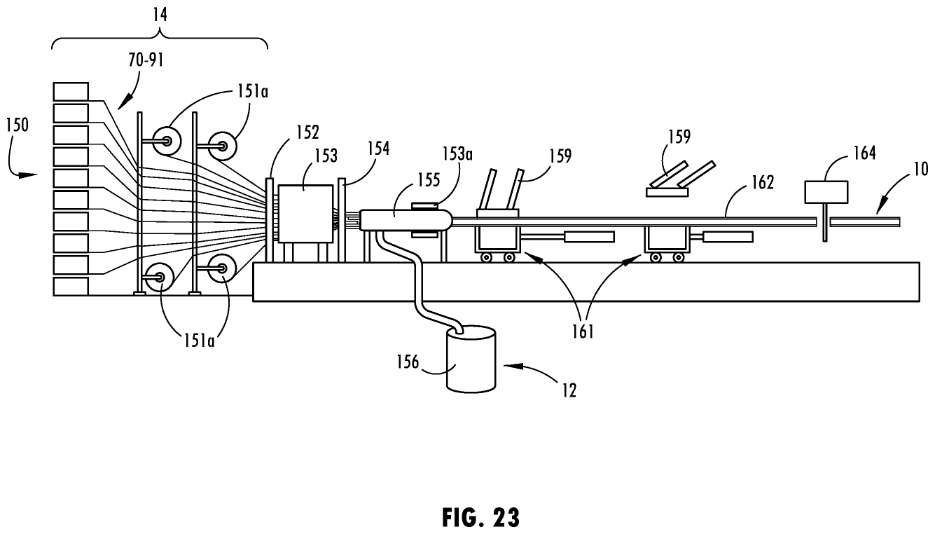

FIG. 7B is an alternative end section of a pultruded profile, showing fiber reinforcements in dashed lines;

FIG. 7C is an alternative end section of a pultruded profile, showing fiber reinforcements in dashed lines;

FIG. 8 is a cross-sectional view of an additional pultruded profile, showing fiber reinforcements and corresponding tracer elements;

FIG. 9 is an end view of the pultruded profile shown in FIG. 8;

FIG. 10 is a cross-sectional view of an additional pultruded profile, showing fiber reinforcements and corresponding tracer elements;

FIG. 11 is an end view of the pultruded profile shown in FIG. 10;

FIG. 12 is an exploded view of a unidirectional carbon fiber fabric;

FIG. 13 is an exploded view of a biaxial carbon fiber fabric;

FIG. 14 is an exploded view of a triaxial carbon fiber fabric;

FIG. 15 is an exploded view of an additional triaxial carbon fiber fabric;

FIG. 16 is a perspective view of a triaxial carbon fiber fabric, showing layers cut-away at stages along the length of the fabric;

FIG. 17 is a perspective view of a fiber fabric, showing tracer elements;

FIG. 17A is an enlarged view of an edge section of the fiber fabric shown in FIG. 17;

FIG. 18 is a cross-sectional view of the fiber fabric shown in FIG. 17, showing a tracer element at an edge of the fiber fabric;

FIG. 19 is an additional cross-sectional view of fiber fabric, showing a tracer element;

FIG. 20 is an further cross-sectional view of fiber fabric, showing a tracer element;

FIG. 21 is yet another cross-sectional view of fiber fabric, showing a tracer element;

FIG. 22 is a perspective view of a pultruding apparatus for manufacturing a curved profile; and

FIG. 23 is a side elevational view of a pultruding apparatus for manufacturing a straight profile.

### DETAILED DESCRIPTION

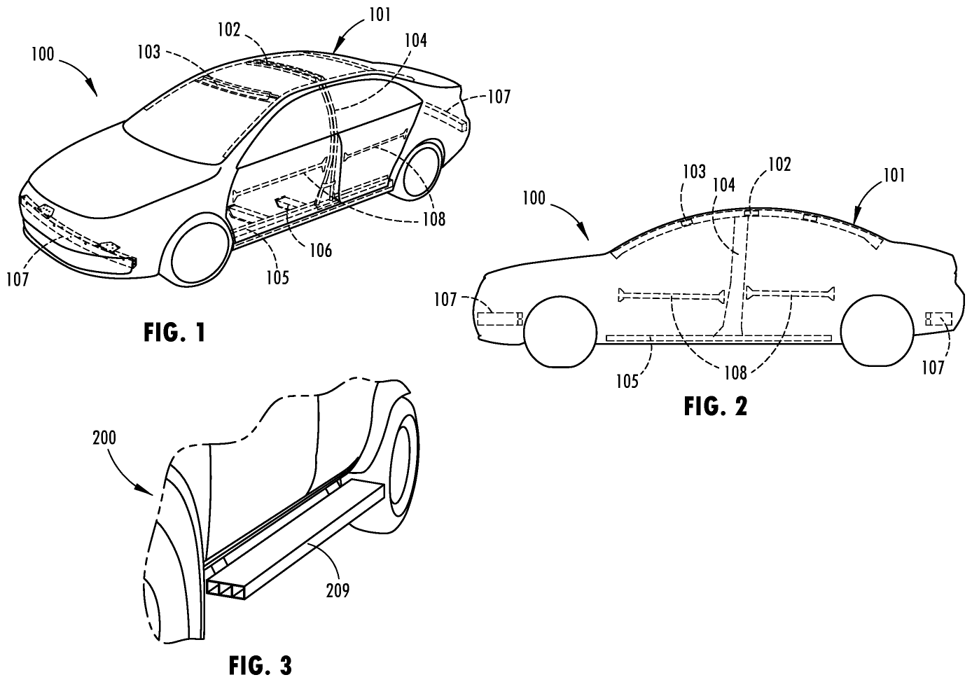

Referring now to the drawings and the illustrative embodiments depicted therein, a pultruded profile is provided that may be used in structural beam applications, such as in components or structures of automotive and marine vehicles, buildings, storage tanks, furniture, and the like. With respect to vehicle applications, pultruded profiles may be used, for example, as structural frame beams, exterior beam components (e.g., luggage rack beams and running boards), impact energy management reinforcement beams that are configured to undergo impact loads at various sections of the beam and receive and distribute such impact loads in a desirable manner, such as door beams and bumper beams. As provided in the exemplary vehicles 100 and 200 shown FIGS. 1-3, a running board 209 is provided and a body structure or vehicle frame 101 has multiple structural beams, one or all of which may be provided as a pultruded profile as described herein.

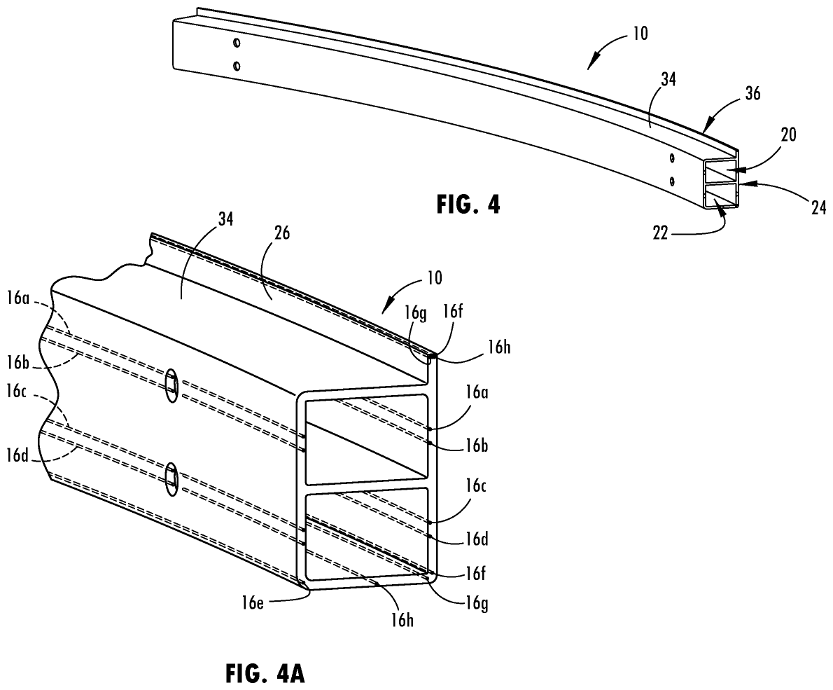

As shown in FIGS. 4-6, a pultruded profile 10 is provided that is made of a resin material 12 (i.e., resin system or resin matrix) and generally continuous fiber reinforcements 14, such as fiber filaments, fiber tow, and fiber fabrics, that extend along a length of the profile 10. The fiber reinforcements 14 are imbedded within the resin material 12 in strategic and desired locations on the cross-sectional shape of the profile 10 during the pultrusion process, such as shown in FIGS. 22 and 23. The fibers reinforcements 14 may include, for example, carbon fiber, fiberglass, E-glass, S-glass, A-glass, aramid, basalt and other natural fibers, or a mixture of these fibrous materials that are held on fiber racks or creels. These fiber reinforcements 14 are pulled off the racks and guided through a resin bath or resin impregnation system so as to wet-out or impregnate the fiber reinforcements with resin before or when being pulled into and through a pultrusion die that heats and forms the pultruded profile with a desired constant cross-sectional shape, as further described below. The cured resin material 14 of the pultruded profile 10 can make visual identification of the fiber fabrics or other fiber filaments difficult, especially when the resin in darkened with pigment or other additives to a similar color as the fiber reinforcements, such as a black resin color to correspond with the color of carbon fibers. Further, interposing various additional fiber reinforcements with the fiber fabrics in the cross-sectional shape of the pultruded profile can make identification of the fiber fabrics difficult, even with the use of near transparent or translucent resin.

As further shown in FIGS. 4-6, one or more tracer element (e.g. the tracer elements 16a-16h) may be provided that extend longitudinally along a portion of at least one of the fiber reinforcements, so as to be visible at a cut end of the pultruded profile 10. The tracer elements may then be used to identify the presence and/or location of the associated fiber reinforcement at the cut end of the pultruded profile. A tracer element, thus, is capable of providing an indication of whether the associated fiber reinforcement (e.g. a fiber fabric) is disposed in the desired location on the cross-sectional shape of the profile 10, which would otherwise be difficult to determine without dissection of the pultruded profile.

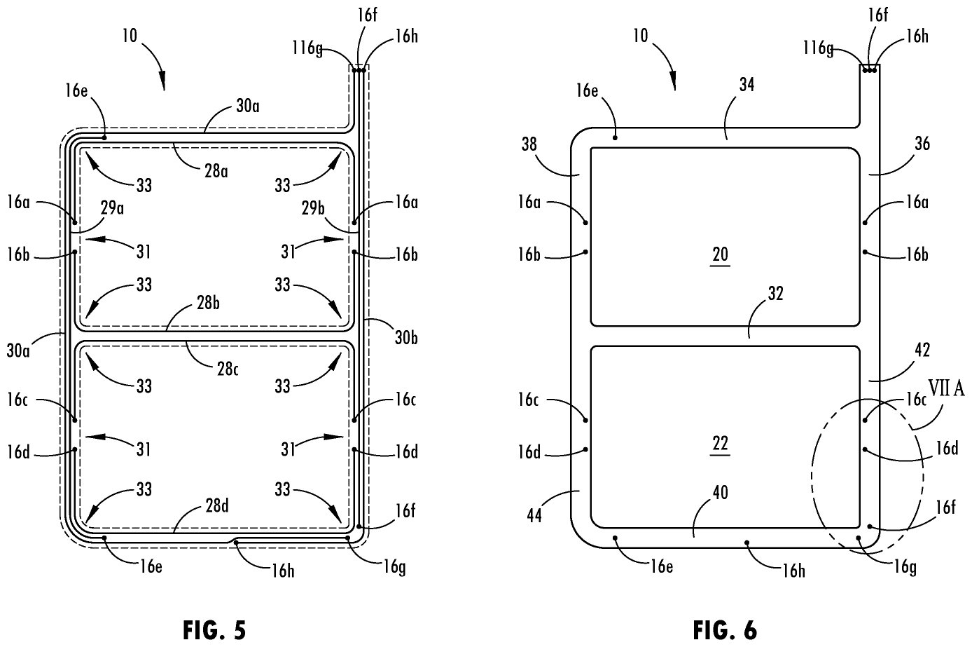

To provide the enhanced visibility, the tracer element 16 may include a material that is different from the fiber reinforcements 14, such as a translucent glass material or a photoluminescent material or other contemplated materials as described herein. The selected material of the tracer element 16 may be capable of being visible by human inspection without use of a visual magnification aid, such as a microscope or the like. The tracer elements 16 are each disposed longitudinally along a consistent portion of a fiber reinforcement, such as at an edge portion of a fiber fabric, as shown in FIGS. 5 and 6. In an additional example, such as shown in FIGS. 8 and 9, the tracer element 116a-116h may be disposed longitudinally along a central portion of the fiber fabric. Additional features shown in FIGS. 8 and 9 that are similar to those shown in FIGS. 5 and 6 are numbered with like reference numbers increased by 100. Further, as shown in FIGS. 10 and 11, the tracer element 216a-216h may be disposed at a location on the fiber fabric so as to be positioned at a desired portion of the cross-sectional shape of the pultruded profile, such as at a corner portion of the cross-section shape, which can make determining the relative location of the fiber fabric on the cross-sectional shape readily identifiable (i.e., without reference to a template or map of the desired locations of the tracer elements on the cross-sectional shape). Also, additional features shown in FIGS. 10 and 11 that are similar to those shown in FIGS. 5 and 6 have reference numbers increased by 200.

With respect to detecting the tracer element, such as the various the tracer elements 16a-16h illustrated at edge portions of the fabrics shown in FIGS. 5 and 6, the tracer element is configured to be identifiable at the cut end of the pultruded profile. Thus, the tracer element may be identified at the cut end of the pultruded profile (FIG. 6) to provide a locating marker to determine whether the corresponding fiber fabric is disposed in the desired location. As shown in FIG. 7A, the tracer element 16d disposed at the edge of the fiber fabric 28d is positioned in the desired location on the cross-sectional shape of the pultruded profile. However, for example, as illustrated in FIGS. 7B and 7C, additional pultruded profiles may have the tracer element 16d that is identifiable at a different location on the cross-sectional shape of the pultruded profile. Specifically, as shown in FIG. 7B, the fiber fabric 28d has started to loosen and the edge has drifted downward, which is evident from the tracer element 16d being located at a lower position. Further, as shown in FIG. 7C, the fiber fabric 28d has shifted further and the edge has drifted downward, which is evident from the tracer element 16d being located at an even lower position than FIG. 17A. Accordingly, the locational variance (i.e., distance) that the tracer element is detected from its desired location may be used to determine whether the pultrusion process needs to be adjusted and/or the produced pultruded profiles with tested for performance standards. For example, a threshold of tracer element locational variance may be implemented to for testing criteria of pultruded profiles.

The pultruded profile may be configured for various applications of different structural beams or members, including the various structural components of a vehicle 100, such as shown in FIGS. 1 and 2 as a roof bow 102, a header 103, a pillar 104, a rocker rail 105 a seat member 106, a bumper reinforcement profile 107, and a door profile 108 of the vehicle frame 101, among other conceivable vehicle components. The pultruded profile 10 may be designed to support and sustain different loading conditions, such as for supporting horizontal spans, like roof bows 102 and rocker rails 105 of a vehicle (FIGS. 1 and 2), or for supporting axial loads, like pillars 104 (FIGS. 1 and 2) of a vehicle frame. Also, the pultruded profile 10 may be designed to undergo various impact forces, such as for vehicle bumper reinforcement beams 107 and door beams 108 (FIGS. 1 and 2) and the like. Further, the pultruded profile 10 may be configured to support intermittent loading and usage, such as for a vehicle running board 209 (FIG. 3), a vehicle roof rack, and other similar vehicle components. The cross-sectional geometry, material type selections, and material placements within the cross-sectional profile of the pultruded profile 10 may be configured for such a particular use and the desired loading and performance characteristics of the pultruded profile, such as the pultruded profile weight, the load capacity of the pultruded profile, force deflection performance of the pultruded profile, and impact performance of the pultruded profile, and the like.

The cross-sectional shape of the pultruded profile may include various shapes and thicknesses for the desired application of the pultruded profile, such as an open profile or a closed profile, which may include a single tube or multi-tubular profile that has one or more hollow interior areas that extend longitudinally within the pultruded profile. The cross-sectional shape of the profile 10, such as shown in FIGS. 4-6, may include at least one hollow interior area 20, 22 spanning longitudinally within the pultruded profile, where a fiber fabric may be disposed at a wall section that borders at least one of the hollow interior areas 20, 22. Further, the cross-sectional shape of the pultruded profile 10 may, optionally, include at least one flange 26 that protrudes from a tubular portion of the pultruded profile, where the fiber fabric may also or alternatively be disposed within the flange 26, such as to provide additional reinforcement at such section.

The profile 10, such as shown in FIGS. 4-6, may be implemented as a bumper reinforcement profile 107, where the front wall 24 of the profile 10 that has the upward protruding flange 26 may be disposed at the outer-facing portion of the profile 10 relative to the vehicle, such as a forward facing portion of the pultruded profile for a front bumper assembly 107, as shown in FIGS. 1 and 2. The cross-sectional profile of the pultruded profile 10 shown in FIG. 6 includes a generally closed profile with a plurality of wall sections that enclose two hollow interior areas 20, 22 that extend longitudinally and continuously within the profile 10. It is understood that the pultruded profile may have a longitudinal curvature, such that during the pultrusion process the fiber reinforcements may flex to conform to the longitudinal curvature of the pultruded profile.

As also shown in FIG. 5, the profile 10 includes several fiber reinforcements, including four interior fiber fabrics 28a-28d, two intermediate fiber fabrics 29a, 29b, and two exterior fiber fabrics 30a-30b that are curved and overlapped in a manner that generally forms the cross-sectional shape of the profile 10. The specific locations of each fiber fabric and the corresponding overlapping areas between the fiber fabrics are designed for the use of the particular profile 10, such that the location of the fabrics should generally be maintained for the profile 10 to perform as designed. The tracer elements 16, as shown in FIGS. 5 and 6 may be used to monitor the location of these fiber fabrics at the cut end of the pultruded profile 10, as shown in FIG. 6.

With further reference to FIG. 5, the interior fiber fabrics 28a-28d are shaped to substantially border the hollow interior areas 20, 22 of the profile 10, where two of the interior fabrics are used at each of the hollow interior areas 20, 22 to generally line or surround the respective hollow interior area 20, 22. As such, each of the interior fiber fabrics 28a-28d have two curved corner portions 33 that form the corners of the interior hollow areas 20, 22, which are illustrated as generally 90 degree angles, although these angles may vary in additional embodiments. The center wall section 32 of the cross-sectional shape of the profile 10 is substantially formed by two of the interior fiber fabrics 28b, 28c that extend in substantially parallel alignment at a generally 90 degree angle away from the front wall 24. Accordingly, the center wall section 32 shown in FIG. 6 may be referred to as a shear wall of the pultruded profile due to its generally horizontal orientation relative to the generally vertical front wall portion 24 that is configured to receive generally horizontally oriented impact forces when used as a bumper reinforcement beam or other similar vehicle component.

As also shown in FIG. 5, the uppermost interior fabric 28a extends along the upper wall section 34 of the profile 10 and partially along the front and rear wall sections 36, 38 that border the upper hollow area 20. Similarly, the lowermost interior fabric 28d extends along the lower wall section 40 of the profile 10 and partially along the front and rear wall sections 42, 44 that border the lower hollow areas 20, 22. The illustrated interior fabrics 28a-28d do not overlap with each other and a spacing 31 is provided between the ends each of the interior fabric reinforcements 28a-28d, such as shown in FIG. 5 at the front wall sections 36, 42 and the rear wall sections 38, 44. It is, however, contemplated that in additional embodiments of the pultruded profile that there may be more or fewer interior fabric reinforcements and that one or more of the interior fabric reinforcements may overlap with each other or at least partially form an exterior surface of a profile.

The exterior fabrics 30a-30b are disposed around portions of the interior fabrics to generally surround the outer surface of the profile 10. The rear exterior fabric 30a shown in FIGS. 5 and 6 spans over a portion of each of the interior fabrics 28a-28d, extending rearward over the lower wall section 40, upward along the rear wall sections 38, 44, and forward over the upper wall section 34. The front or outermost exterior fabric 30b shown in FIG. 5 also spans over a portion of each of the interior fabrics 28a-28d, extending forward from an intermediate extent of the lower wall section 40 and upward along the front wall sections 36, 42, which is also the front wall 24 (FIG. 4). Further, the front or outermost exterior fabric 30b shown in FIG. 5 overlaps the lower end of the rear exterior fabric 30a at the lower wall section, while the upper ends of the exterior fabrics 30a-30b extend upward together to form the flange 26 that protrudes upward along the front wall portion 24 of the profile 10 (FIG. 4).

The intermediate fabrics 29a, 29b are disposed between the exterior fabrics 30a, 30b and the interior fabrics 28a-28d, generally along the front wall 24 (FIG. 4) and rear wall of the profile 10. The rear intermediate fabric 29a shown in FIGS. 5 spans over a portion of each of the interior fabrics 28a-28d, extending along the rear wall sections 38, 44. The front intermediate fabric 29b shown in FIG. 5 also spans over a portion of each of the interior fabrics 28a-28d, extending along the front wall sections 36, 42 and into the flange 26 that protrudes upward from the front wall portion 24 of the profile 10 (FIG. 4).

The tracer elements 16 shown in FIGS. 5 and 6 are disposed at the edges of each fabrics. In one example, the tracer element may include a material that is visible distinct or identifiable from the fiber reinforcements in the profile. For instance, the tracer element may include a high visibility material, such as a photoluminescent material or florescent material or reflective material or brightly colored material. The high visibility material may be disposed at the fiber fabric in various configurations, such as by incorporating the material entirely or partially into the tracer element. For example, the distinct material of the tracer element 16 may be disposed at the fiber fabric in strip of bead of material (e.g., a tape, paint, or resin form or the like), such as shown for example in FIG. 21. As another example, the distinct material may be integrated with a filament of the tracer element that is attached to the fiber fabric or otherwise integrated as a filament of the fiber fabric, such as shown in the examples illustrated in FIGS. 18-20. The high visibility material may provide its visibility with the application of various lighting conditions or radiation applications, such as filtered or unfiltered visible light, ultraviolet (UV) light, infrared (IR) light, or other visible or invisible radiation.

In another example, the tracer elements may include a translucent filament, such as an optical fiber filament, that is attached to the fiber fabric or otherwise integrated as a filament of the fiber fabric. The translucent filament may act as a light guide or light pipe that is configured to receive visible light at one end and transmit the light to be visible at the cut end of the pultruded profile 10. For instance, the formed pultruded profile may be tested after it has two opposing cut ends that define the length of the pultruded profile, such as by directing light at one end of the pultruded profile and viewing the illuminated tracer element at the opposing cut end. Alternatively, the light may be transmitted through the translucent filament during production, such that the exposed cut end of the pultruded member may be inspected in the pultrusion machine before the pultruded profile is cut to length.

In the example of the tracer element being a separate filament, whether translucent or high visibility material or otherwise, it may be disposed at the fiber fabric, by being affixed in a desired manner or by being integrally formed as a filament of the fiber fabric. For instance, the tracer element may be laced or sewn into the fiber fabric (e.g., as shown in FIGS. 18 and 19), affixed with a mechanical fastener, such as a staple or suture or the like, or may otherwise be adhered to a surface of the fiber fabric, such as via an adhesive or resin or the like (e.g., as shown in FIG. 20).

The fiber fabric or fabrics disposed in the pultruded profile may be a woven fabric construction or a non-crimped, stitched fabric construction, where the fabrics may include unidirectional, biaxial, and triaxial composite layering configurations, such as shown in FIGS. 12-16. As shown in FIG. 12, the unidirectional fabric 50 may have a thickness of about 0.69 mm and a tow of about 50,000 filament/tow, where the unidirectional carbon fiber may be stitched together. The biaxial fabric 52, such as shown in FIG. 13, has a thickness of about 0.64 mm and a tow of about 12,000 filaments/tow. The triaxial fabrics 54, 56, such as shown in FIGS. 14-16, may have a thickness of about 0.6 mm and a tow of about 12,000 filaments/tow for the two 45 degree orientation layers and about 24,000 filaments/tow for the zero degree orientation. As further shown in FIGS. 16 and 17, the fabric 56 may include a stitch 58 that extends through each layer of directionally oriented

With reference to FIG. 5, the interior fabric reinforcements 28a-28d and the forward or outermost exterior fabric reinforcement 30b shown in FIG. 3 is formed as a triaxial fabric or weave configuration, whereas the rear exterior fabric reinforcement 30a is formed as a biaxial fabric or weave configuration. The fiber reinforcements used in the pultruded profile may thereby include at least two different fabrics, each with differently-oriented fibers and each strategically placed for optimal pultruded profile properties. The fibers may be of a same or similar material (such as carbon fiber), or could be a combination of different materials (such as carbon fiber and fiberglass or the like). However, it is understood that the wall sections and corresponding fabric reinforcements may be formed with various alternative configurations and material combinations.

The fiber reinforcements may be arranged in various configurations, locations, and orientations, such as by using fabrics, tows, rovings, and bundles to achieve desired fiber volume densities, bending and strength properties, and crack-resisting properties. The structural member may include a uniform distribution and density of reinforcement, including at least about 30% fiber volume fraction (FVF) (i.e. volume of elongated reinforcement fibers divided by total area of fibers and polymer), or more preferably about 40% to 80% FVF, and most preferably at least about 50% to 70% FVF. As used herein, the word “reinforcement” is intended to broadly include length-extending reinforcing fibers of all types, such as individual fibers, twisted bundles, tows, rovings, braided fibers, fiber mats (including woven-flat, woven-3D, fabric with core, tailored fabric, stitched fabric, hybrid fabric with unique arrangement or combination of fiber fabrics), and other fiber arrangements (such as intermittently placed fabric sections placed along and/or in the pultruded profile). The word “fabric” includes fibers stitched or woven or otherwise secured together to form a “sheet” or mat of fibers. It is noted that the FVF can be varied at different locations within a pultruded part for optimal performance, such as by placing more or less fibers at and/or extending around corners and along walls where more (or less) stress may occur or where the stress needs to be well distributed. The reinforcements are pre-positioned by a guide as they enter an injection die 155 (FIGS. 22 and 23), thus placing them at strategic locations in the pultruded profile.

The polymeric material, such as a thermoplastic resin, and other continuous reinforcements, such as individual fiber filaments may be disposed in the open areas of the cross-sectional profile, such as shown in FIG. 22 being disposed at the areas between the interior and exterior fabric reinforcements. The pultrudable polymeric material may be a two-part thermoset polyurethane with embedded carbon reinforcement fibers. Two-part thermoset polyurethane materials and carbon fiber reinforcements are known and commercially available, such that persons skilled in this art will understand and can obtain these products. Notably, two-part thermoset polyrethane has a low viscosity prior to chemical reaction and set up, and has good wet-out characteristics and reinforcement adhesion characteristics.

The pultrusion process may provide an injection die that is shaped or configured to form a desired cross-sectional profile of the pultruded profile and may also be shaped or configured to form a desired longitudinal curvature of the pultruded profile. The tracer element may have a sufficiently high compressive strength and flexibility to be used in the pultrusion process, while also maintaining the performance characteristics of the resulting pultruded structural member. During pultrusion of the profile 10, such as shown in FIGS. 22 and 23, the polymeric material 12 is provided with a high density of continuous reinforcements 14, with a majority of the fibers oriented to extending along a length of the profile 10 and the tracer elements 16 being a continuous, flexible, non-rigid material that is longitudinally drawn into a pultrusion die 155 (also called an “injection die”) to similarly extend along the length of the profile 10.

The pultrusion processes may use an apparatus 149, such as shown in FIG. 22, for forming a pultruded profile. A rack 150 holds rolls of continuous reinforcements 70-91, which are fed through preforming guides 151 (which can also double as cloth racks 151a) into material guides 152 and 154, which gives them specific locations and orientations. A preheater 153 can be used to warm the reinforcements at or downstream of the guide 152 (and/or guide 154) to assist in optimal uniform coating and adhesion of polymer to the reinforcements when passing into and through the pultrusion die 155. The reinforcements 70-91 extend from the guide 154 into the pultrusion die 155 (also called an “injection die”) where polymer (also called “resin”) is delivered from a resin supply tank 156. The polymer is pumped under pressure from the resin supply tank 156 into the pultrusion die 155 with sufficient pressure and rate to fully wet and coat all reinforcements 70-91, with the rate and pressure and reinforcement speed being sufficient to achieve a desired fiber volume fraction and desired uniformity of reinforcement density throughout the pultruded profile. The tracer element 16 may also partially absorb the resin that forms the polymeric material in the injection die 155 that is shaped or configured to form the desired cross-sectional profile of the profile 10.

The injection die 155 is heated (e.g. heater 153a) and optionally is vibrated if necessary to assure full coating of all reinforcement and to assure proper reaction of the two-part resin. A pulling mechanism 158 includes one or more sets of grippers/clamps 159 and hydraulic rams 160 that cooperate to support the pultruded continuous pultruded profile 162 as the pultruded profile is pulled from (extends from) the injection die 155. The pulling mechanism 158 provides pulling forces that pull the pultrusion out of the pultrusion die 155, doing so while relying mostly on a strength of the reinforcement (since the polymer is not yet fully cured) and doing so with sufficient force to cause the pultrusion process to operate effectively. The pulling mechanism 158 may pull with a force that is sufficiently limited so that it does not undesirably stretch and elongate or distort the continuous pultruded profile 162. The pultruded profile 162 continues away from the pultrusion die 155 onto a cooling station 163. Once the pultruded profile 162 is sufficiently cooled to maintain its shape, a cutoff device such as cut-off saw 164 cuts the continuous pultruded profile 162 into sections of desired length. As shown in FIG. 22, the injection die 155 is shaped to produce a curved/swept pultruded continuous pultruded profile 10, and the cooling station 163 may have a curved support for the pultruded continuous pultruded profile as it cools and cures.

Alternatively, FIG. 23 illustrates a pultrusion process that uses an apparatus to form pultruded profile having a linear shape, such as a straight section pultruded profile 10. It is contemplated that the sweeping operation can be performed in-line as shown in FIG. 22, or off-line (prior to the polymer being fully cured, when thermoset polymeric materials are used).

It is contemplated that a design of the pultruded profile design can “help” the process for incorporating a sweep into the resulting pultruded profile. For example, profile walls and reinforcements may be designed to cause a sweep as the polymeric material cures, cools, and shrinks. For example, if a front wall of a pultruded profile is thicker than a rear wall, the thicker front wall will cool at a different rate and dimensionally shrink a different amount, potentially causing a natural sweep in the pultruded profile to occur during final cure and set up of the polymeric material. The reinforcement density and reinforcing fabrics can be varied between different walls to also cause a different dimensional shrink. As illustrated, the downstream sweeping process includes, in significant part, supporting the pultruded profile as it naturally curves as the polymer cures and cools. For example, the downstream sweeping mechanism can include a curved portion of the cooling table that is specifically shaped to support the pultruded profile as it cools and cures to reach a desired curvature. Also, the pulling mechanism can press the pultruded profile against the table during the final cure and cooling process, thus providing more consistent dimensional accuracy to the sweep of the pultruded profile. Final curvature of a pultruded profile can also be affected by controlling the temperature decline on different sides of the pultruded profile. Thus several things can be done to impart a desired sweep into the pultruded profile.

As noted above, it is contemplated that different polymeric and reinforcement fibers can be used depending on a particular profile's functional design requirements. For example, it is contemplated that other fibers can be used instead of carbon fibers, such as aramid, basalt, or glass fibers. Also, there are different grades and diametrical sizes of fibers (carbon and others). Also, different woven fabrics and different fabric locations will produce different pultruded profile properties. It is contemplated that many different thermoset (or thermoplastic) materials can be use besides polyurethane. The present polyurethane is a two-part fast-curing polymer that will cure to a self-holding shape in about 5-30 seconds, though slower curing polymers can be used for optimization of the pultrusion process, such as if the pultrusion process is slowed for control reasons. It is contemplated that the reinforcement can include different types of materials, such as glass fibers in one location and carbon fibers in other (or similar) locations.

Notably, the present pultruded profile incorporates fabrics having fibers woven to extend at angles to a longitudinal direction. For example, fabrics can have fibers extending at an angle to a longitudinal direction, such as at 45 or 90 degrees. This provides significant strength and stress distribution by providing a structural mechanism for handling non-longitudinal stress and loads. For example, the angled fibers provide improved strength, and also reduce a speed and tendency of longitudinal crack propagation upon failure. Also, where fabrics and/or angled fibers extend across corners and joined walls, the angled fibers transmit stress away from the corners and joined walls. Also, fabrics can be used in high-stress areas having fibers that are better adapted for the expected stress at that location, such as at attachment sites. Also, particularly woven and bundle combinations and stitches can be selectively positioned in the pultrusion. By selectively using fabrics, additional strength and localized region-specific load resistance can be provided in selected areas of a pultruded profile. Concurrently, areas of lower stress can be “adjusted” to minimize cost and weight, while optimizing overall the pultrusion process.

For purposes of this disclosure, the terms “upper,” “lower,” “right,” “left,” “rear,” “front,” “vertical,” “horizontal,” “inner,” “outer,” “inner-facing,” “outer-facing,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A pultruded profile comprising:
a plurality of fiber reinforcements longitudinally extending parallel relative to each other;
a tracer element disposed at and extending longitudinally along a fiber reinforcement of the plurality of fiber reinforcements; and
a resin disposed over the plurality of fiber reinforcements and the tracer element to form a consistent cross-sectional shape continuously along a length of the pultruded profile, wherein the tracer element is identifiable at a cut end of the pultruded profile to provide an indication of a location of the fiber reinforcement of the plurality of fiber reinforcements in the pultruded profile.

2. The pultruded profile of claim 1, wherein the fiber reinforcement comprises a fiber fabric configured to be disposed in a desired location in the pultruded profile.

3. The pultruded profile of claim 1, wherein the tracer element comprises a material that is different from the plurality of fiber reinforcements and is capable of being detected at the cut end to determine a location of the tracer element on the cut end of the pultruded profile.

4. The pultruded profile of claim 1, wherein the resin comprises a pigment dispersed between the plurality of fiber reinforcements that corresponds with a color of a carbon fiber material of the plurality of fiber reinforcements.

5. The pultruded profile of claim 4, wherein the tracer element comprises a material that is visually identifiable from the pigment of the resin.

6. The pultruded profile of claim 4, wherein the tracer element comprises a material that is configured to be visually identifiable from the pigment of the resin by human inspection in visible light without use of a visual magnification aid.

7. The pultruded profile of claim 1, wherein the tracer element comprises an optical fiber filament configured to receive light at an opposite end of the pultruded profile from the cut end so as to illuminate the optical fiber filament at the cut end of the pultruded profile.

8. The pultruded profile of claim 1, wherein the tracer element comprises a metal wire.

9. The pultruded profile of claim 1, wherein the fiber reinforcement comprises a fiber fabric, and wherein the tracer element is disposed at an edge of the fiber fabric.

10. The pultruded profile of claim 1, wherein the fiber reinforcement comprises a plurality of carbon fibers attached together in parallel alignment with each other to define a fiber fabric having a width defined a first edge and a second edge, and wherein the tracer element is attached at the first edge and a second tracer element is attached at a second edge of the fiber fabric.

11. The pultruded profile of claim 1, wherein the consistent cross-sectional shape of the pultruded profile comprises a plurality of wall sections that enclose at least one hollow interior area that extend longitudinally and continuously within the pultruded profile.

12. The pultruded profile of claim 11, wherein the fiber reinforcement comprises a fiber fabric extending longitudinally along the length of the pultruded profile, wherein the fiber fabric is configured to be disposed in a desired location on the consistent cross-sectional shape that is disposed along two of the plurality of wall sections, and wherein the identification of the tracer element at the cut end of the pultruded profile provides an indication of the whether the location of the fiber fabric corresponds with the desired location.

13. The pultruded profile of claim 12, wherein the fiber fabric comprises one of a woven fabric construction or a stitched fabric construction.

14. The pultruded profile of claim 12, wherein the fiber fabric comprises a stitched fabric that comprises one of a unidirectional fabric or a multiaxial fabric.

15. A pultruded profile comprising:
a plurality of fiber reinforcements longitudinally extending parallel relative to each other, wherein the plurality of fiber reinforcements comprises a fiber fabric;
a tracer element attached at and extending longitudinally along a portion of the fiber fabric, wherein the tracer element comprises a material that is different from the plurality of fiber reinforcements; and
a resin disposed over the plurality of fiber reinforcements and the tracer element to form a consistent cross-sectional shape continuously along a length of the pultruded profile, wherein the tracer element is identifiable at a cut end of the pultruded profile.

16. A method of forming a pultruded profile, said method comprising:
pulling a plurality of fiber reinforcements into and through a pultrusion die in a desired arrangement within the cross-sectional shape of the pultrusion die;
wherein the desired arrangement includes positioning a fiber fabric of the plurality of fiber reinforcements in a desired location on the cross-sectional shape;
wherein a tracer element is disposed longitudinally along a portion of the fiber fabric;
injecting a resin over the plurality of fiber reinforcements in the pultrusion die to form an elongated profile with the cross-sectional shape; and
cutting the elongated profile to form a cut end of the pultruded profile, wherein the tracer element is configured to be identifiable at the cut end of the pultruded profile.

17. The method of claim 16, further comprising:
identifying the tracer element at the cut end of the pultruded profile to provide a locating marker to determine whether the fiber fabric is disposed in the desired location

18. The method of claim 16, wherein the cross-sectional shape of the pultruded profile includes at least one hollow interior area extending longitudinally within the pultruded profile, and wherein the fiber fabric is disposed along at least one wall section that borders the hollow interior area extending longitudinally along of the pultruded profile.

19. The method of claim 16, further comprising:
directing a sensor at the cut end of the pultruded profile to detect the tracer element for identifying at least one of: (a) the presence of the fiber fabric in the pultruded profile or (b) the location of the fiber fabric in the cross-sectional shape of the pultruded profile.

20. The method of claim 19, wherein the sensor is configured to detect the tracer element based on identifying a threshold measurement at least one of: (a) visible light waves, (b) heat, (c) electricity, or (d) magnetic waves.
